(19) United States
(12) Patent Application Publication
(10) Pub. No.: US 2002/0147632 A1
(43) Pub. Date: Oct. 10, 2002

(54) Contact center management

(76) Inventors: Ian Peter Winham, Putney (GB); Sheena Wilson, Baltimore, MD (US); Jim Perkins, Omaha, NE (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/776,674

(22) Filed: Feb. 6, 2001

(51) Int. Cl. G06F 17/60

(52) U.S. Cl. 705/11

(57) ABSTRACT

A method of managing a contact center is disclosed which comprises preparation of a plan for a forthcoming period, such as one working day, on a per Agent basis for a plurality of Agents. Variance from his plan is measured for each of a plurality of shorter periods, not exceeding one half working day. Communication to the Agent of variances that exceed a threshold is performed quickly, at least at the frequency of the shorter periods. Optionally, variances that do not exceed the threshold are noted for subsequent discussion, for example at a scheduled meeting.

The present invention relates to management of contact centers.

Contact centers have proved notoriously difficult to manage. Reasons for failures to meet performance targets can be difficult to identify much less remedy. Because of the continuous nature of the work even a short-term shortfall in performance can be near-impossible to recover from.

It is an object of the present invention to ameliorate these problems.

According to a first aspect of the present invention, there is provided a method of managing a plurality of agents working for a contact center, comprising preparing a plan for each agent for a forthcoming first period, which plan comprises at least one performance indicator value for each of a plurality of second periods of no more than half a day, shorter than the first period, deriving, at least at the frequency of the second period a variance from the plan, for each of the agents, and communicating, at least at the frequency of the second period, with each agent whose variance exceeds a threshold

The invention is not to be confused with Contact Center Managers or Team Leaders dealing with complaints from members of the public. Clearly a complaint is a serious matter which needs to be addressed as a matter of urgency. The crucial distinction here is that the procedure is proactive and encompasses and least one and preferably a range of service and/or performance measures. The performance indication might be values for each of one or more key performance indicators (KPI) and the amount by which the performance differs from this is called the variance. For example, consider a performance indicator whose target is 85% of time is either involved in calls or in wrapping-up calls. A shortfall is an issue as it reflects poor planning and therefore additional cost) so the Team Leader should consider the situation at least every half day. It is preferred, however, to use a shorter period of between one half hour and two hours with one hour (or thereabouts) being preferred, A period of two hours (or thereabouts) is acceptable but does not allow the same level of responsiveness while a period of half an hour (or thereabouts) provides greater responsiveness but with greater management overhead. The reason for this is that a significant shortfall may be impossible to recover from, at least without diverting a significant number of Agents from other tasks for the remainder of the day,

It is worth noting that the Agents may not all be physically co-located. Consequently, the Agents work for a contact Center rather than necessarily in the contact Center.

All variances that exceed the threshold should be communicated as soon as possible, and certainly at Agent level within the predefined time period. Understanding and management of these variances in a timely manner will enable Team Leaders to maximise the positives and minimise the impact of any negatives.

In addition, less serious points (i.e. variances that do not exceed the threshold) arising are preferably noted for subsequent action such as discussion at a suitable time. These points still need to be addressed in the medium to longer term. Ideally, these points are addressed at a quiet time or at a regular, pre-scheduled meeting.

Also a regular meeting is preferably scheduled between the Team Leaders and higher management.

In a preferred embodiment of the method the method is carried out by a Team Leader who is also responsible for generating reports. Such reports may be generated by hand or automatically. Experience has shown that reports generated by hand have greater impact than reports generated by software such as spreadsheet programs. However, the latter are less time consuming to produce than reports generated personally by hand.

In a preferred embodiment the points are addressed on an individual basis, i.e., a report is generated for each of the Agents and is considered independently. The discussion of consequent action points may be more widely applicable but, still further preferably, the discussion of these should be held over until the scheduled meeting. Raising points unnecessarily with Agents for whom the particular point is not a problem actually has a detrimental effect on morale and performance.

The first time period will generally be determined by higher management.

The Team Leader or higher management may decide that variance from the plan is due to unrealistic targets and so the value of at least one performance indicator may be adjusted in response to variance.

The present invention will now be described by way of non-limiting examples, with reference to the accompanying drawings, in which:

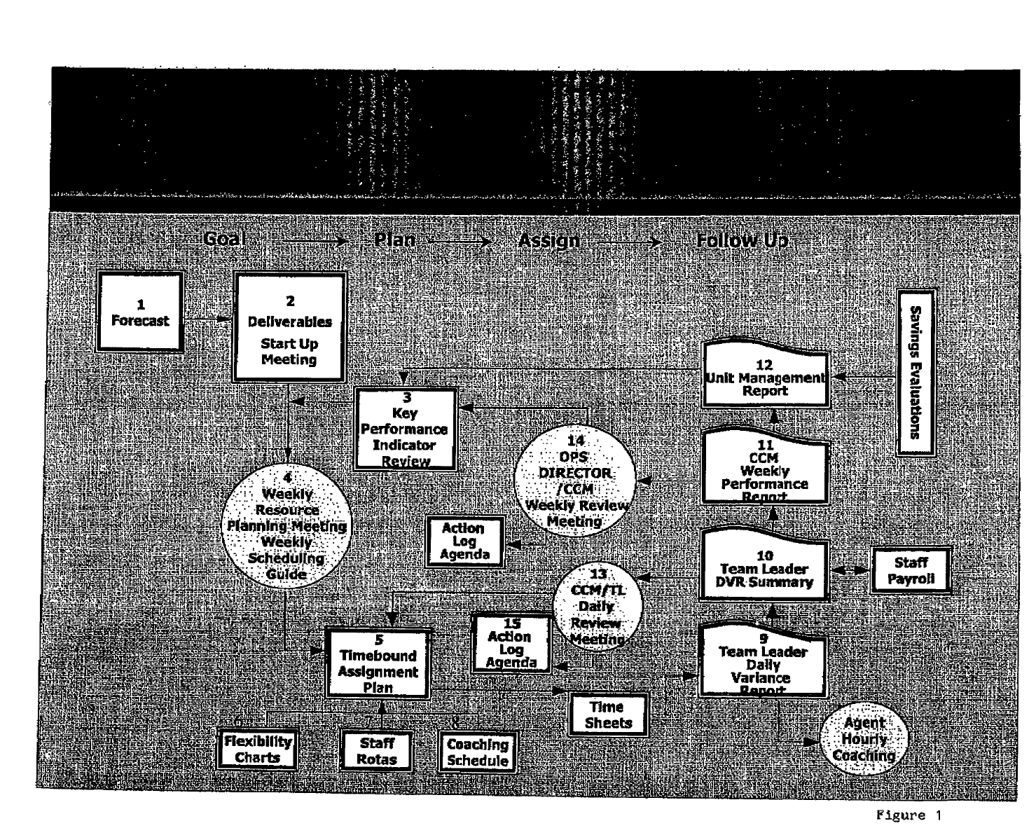

FIG. 1 shows a block diagram of an overall process of which an embodiment according to the present invention forms part,

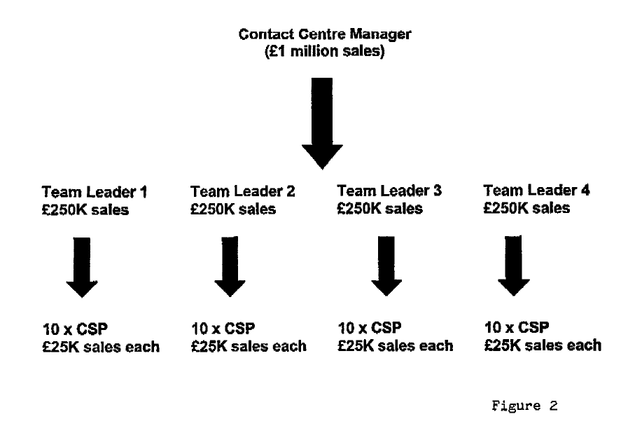

FIG. 2 shows a goals roll-down process;

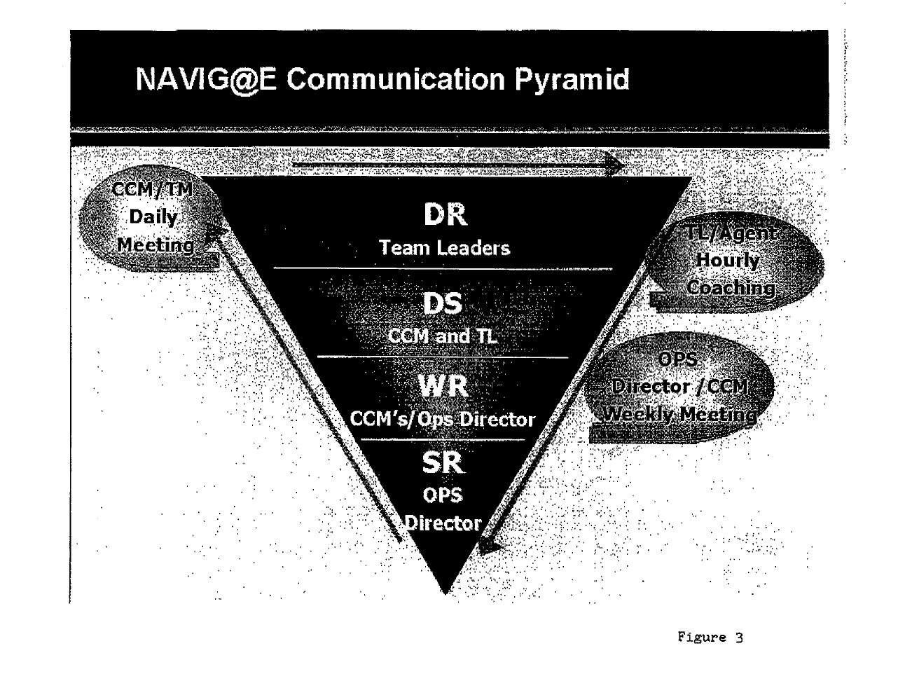

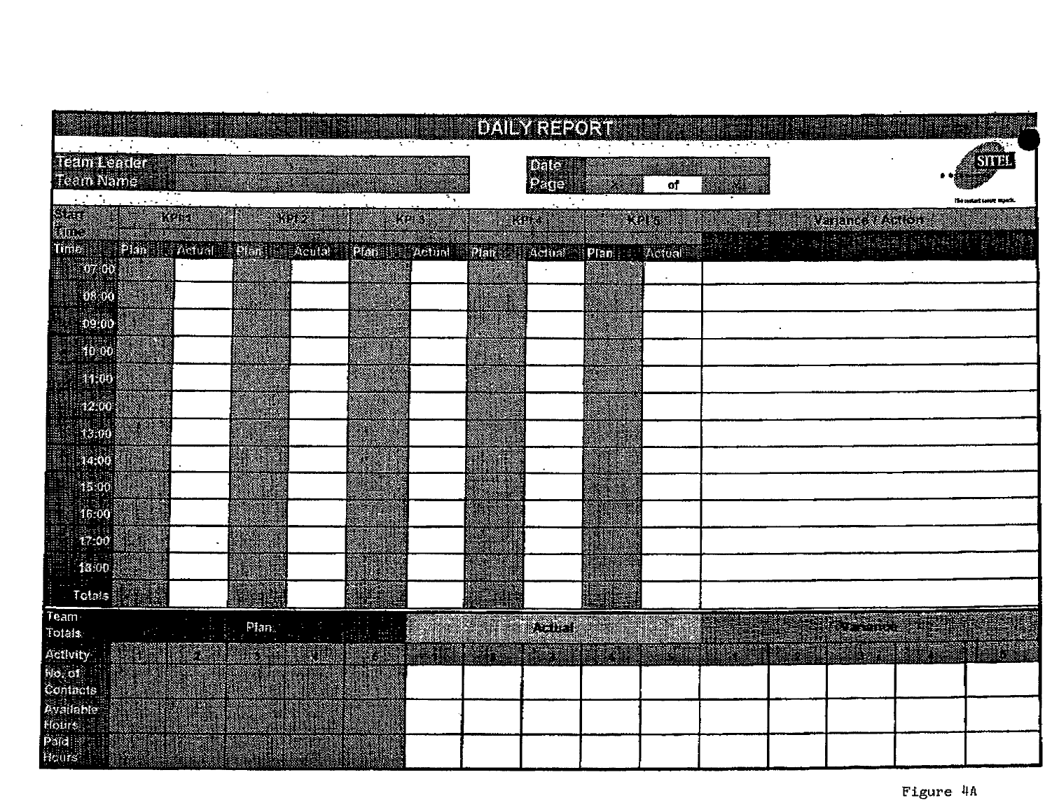

FIG. 3 shows a communications pyramid;

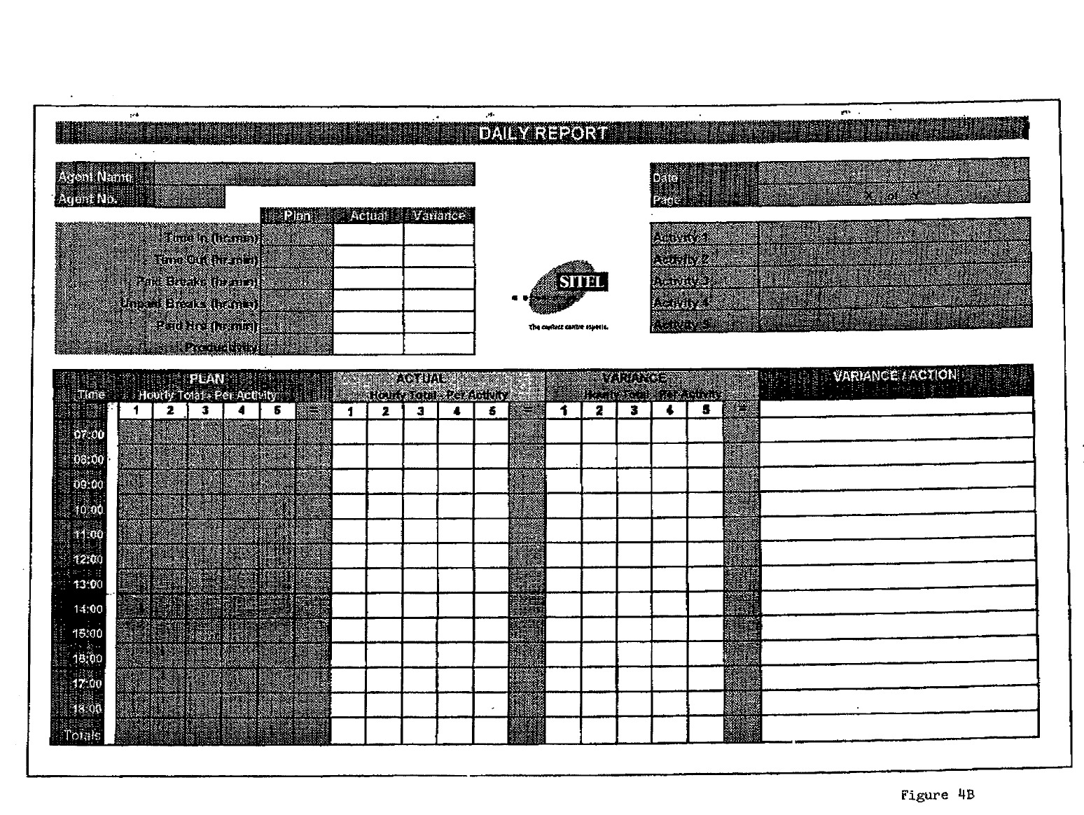

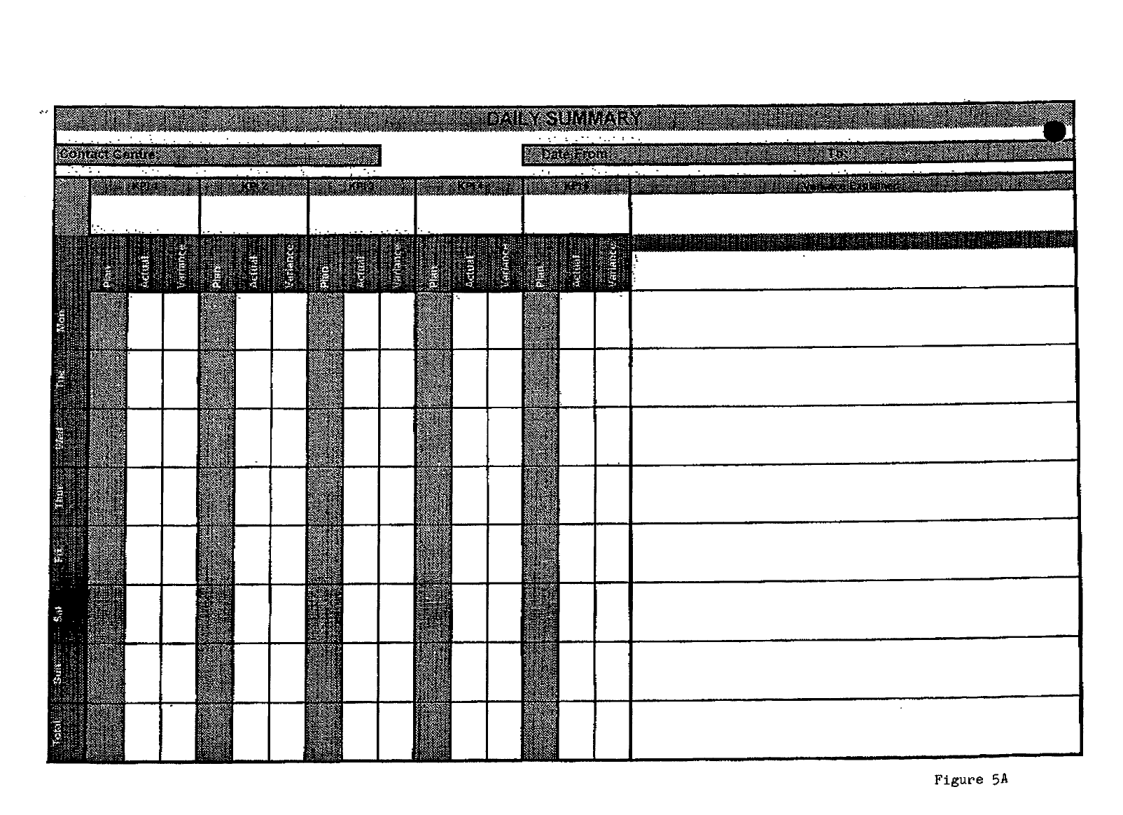

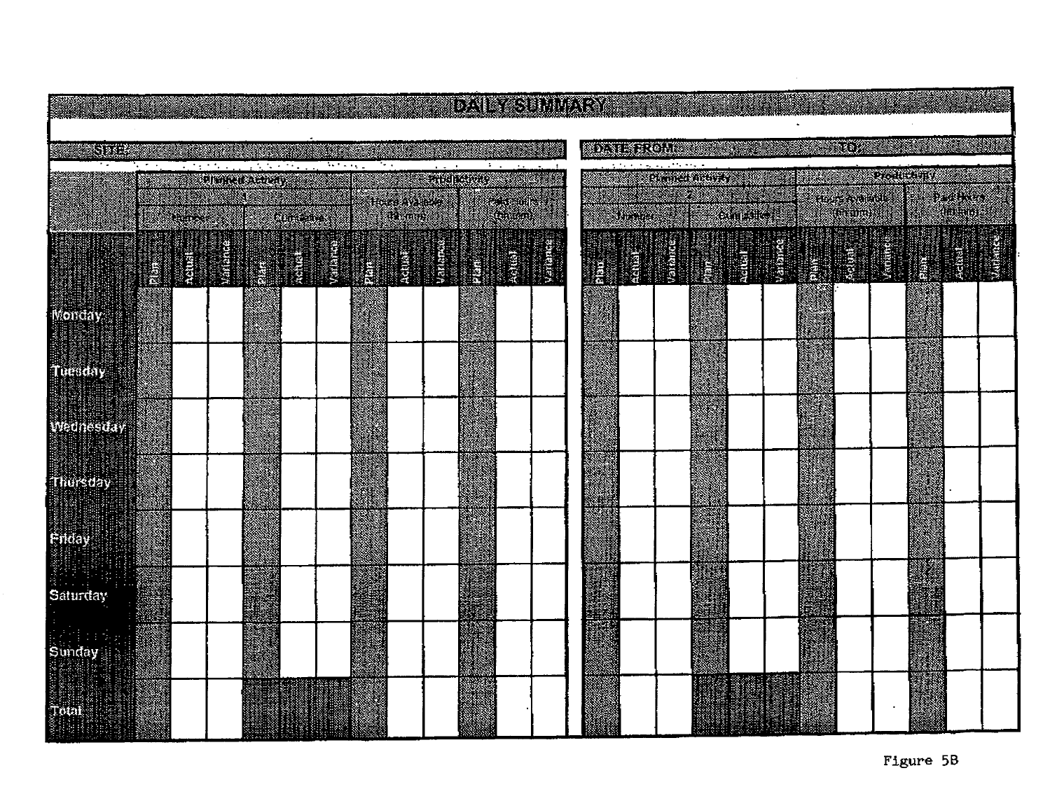

FIG. 4A shows section I of a daily report;

FIG. 4B shows section II of a daily report;

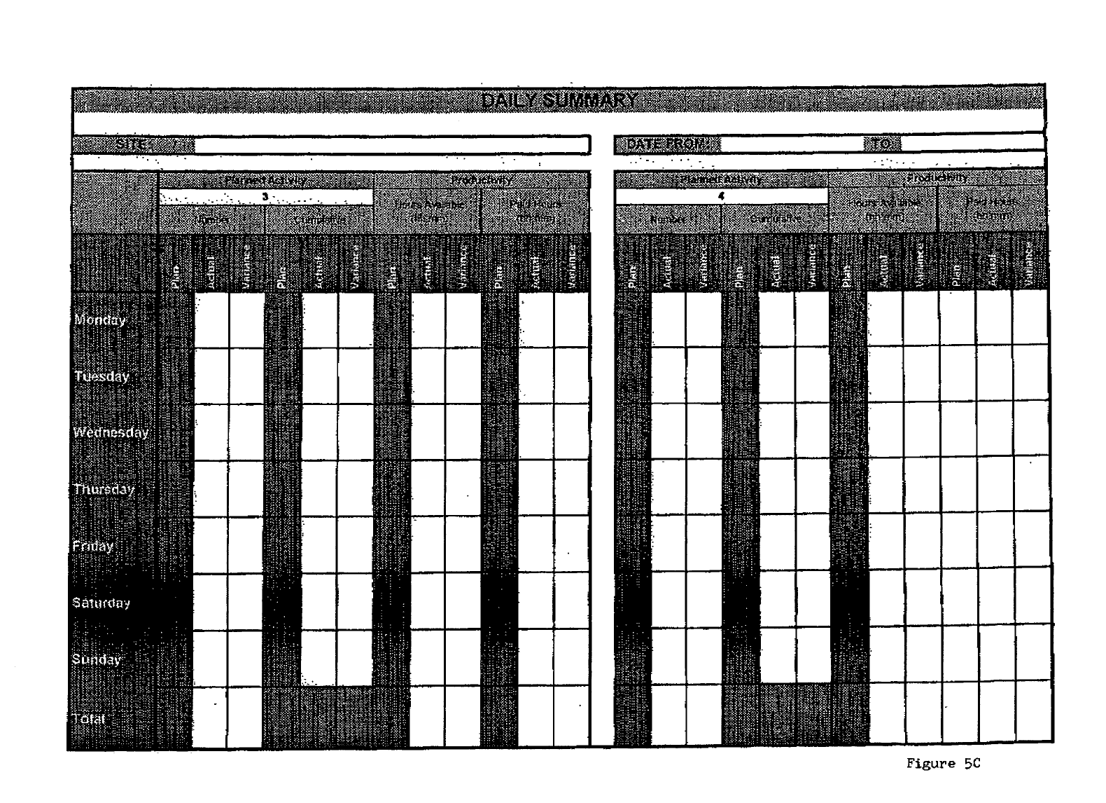

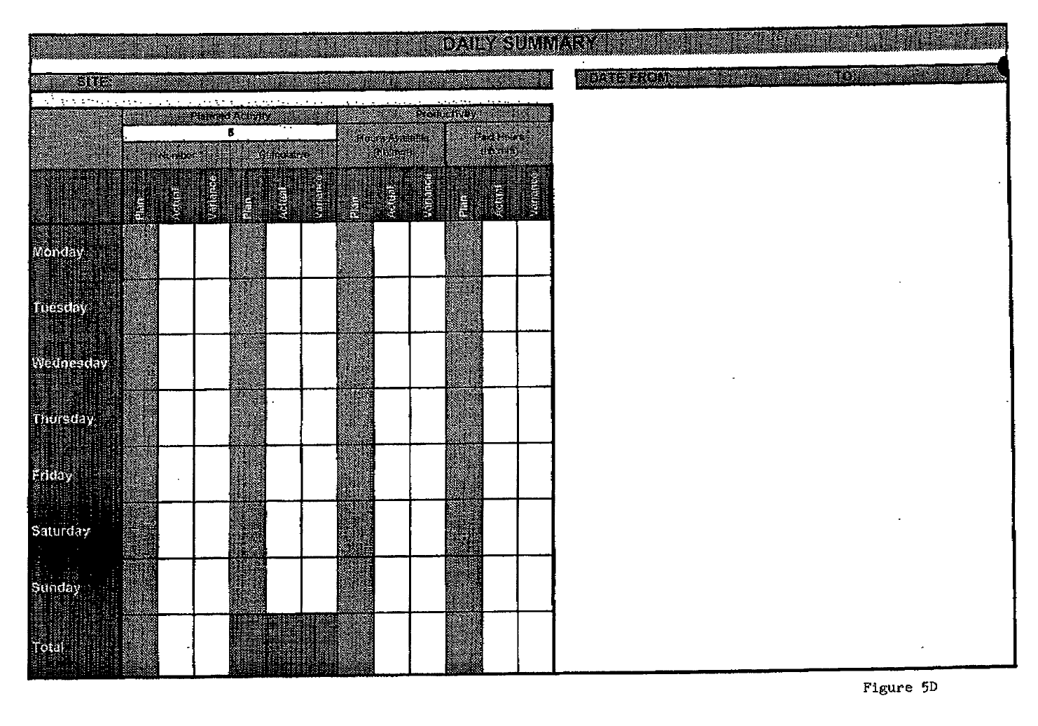

FIG. 5A, 5B, 5C and 5D show a blank daily summary,

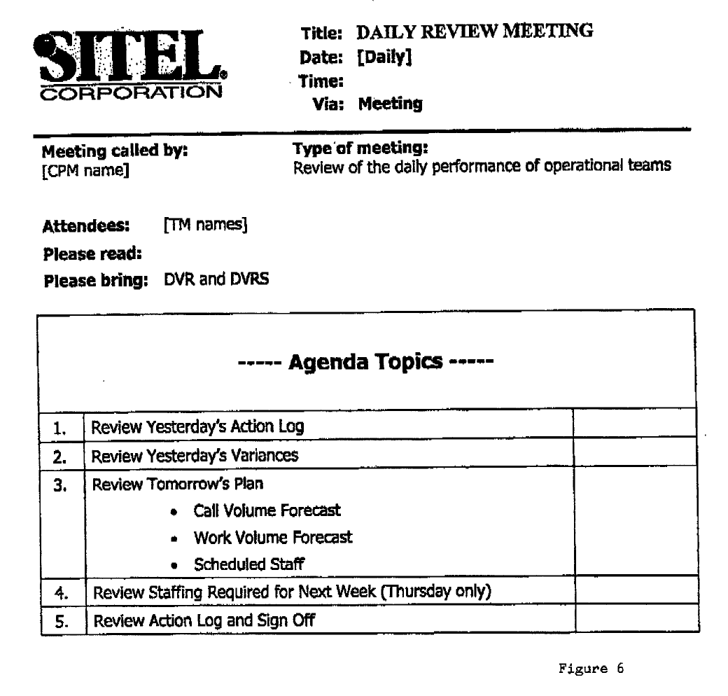

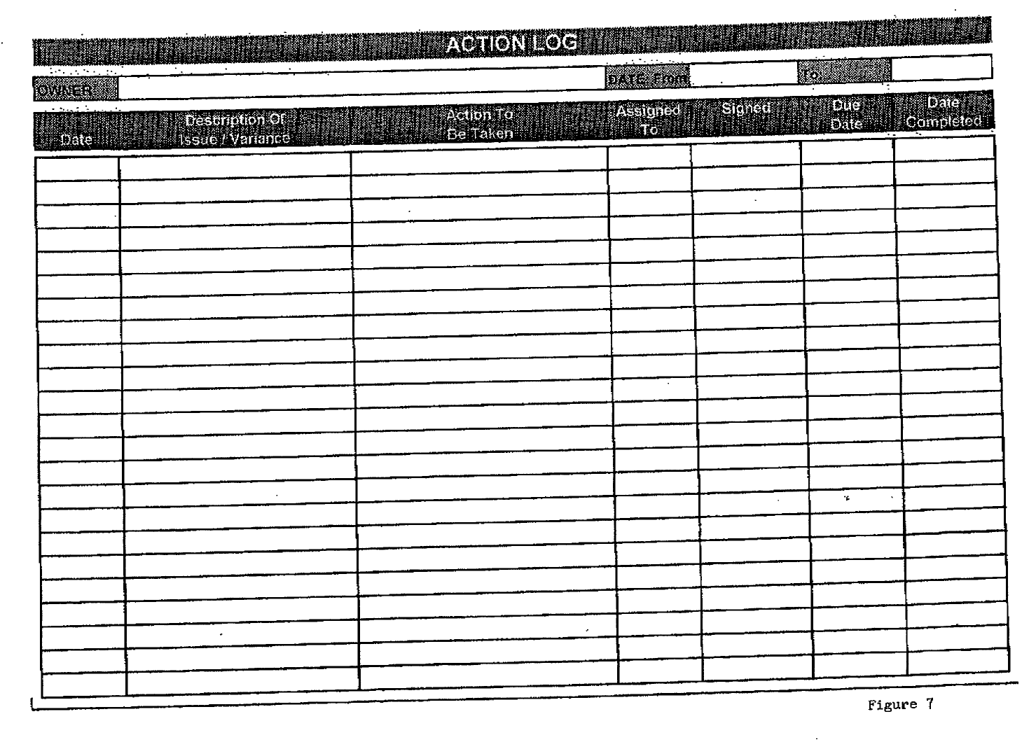

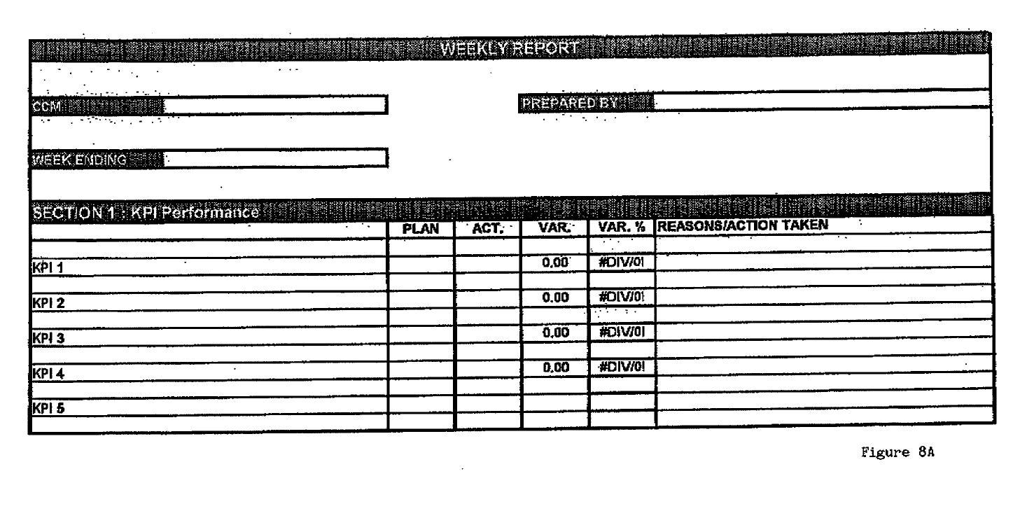

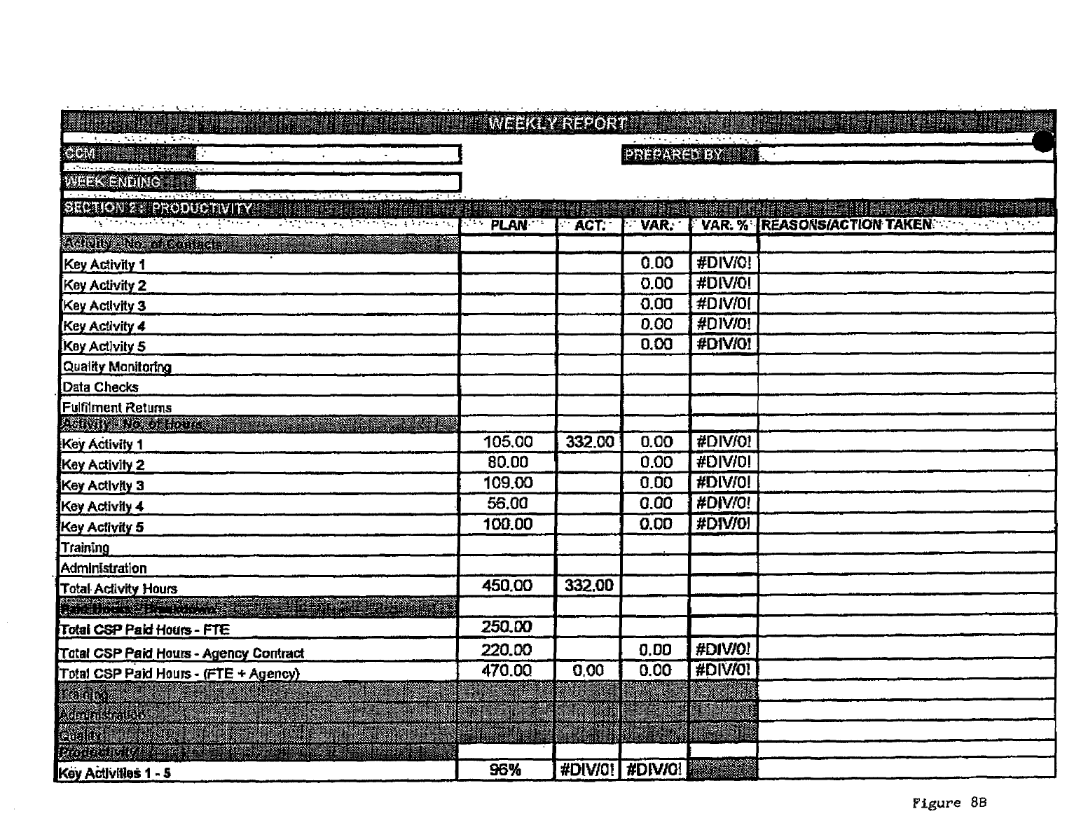

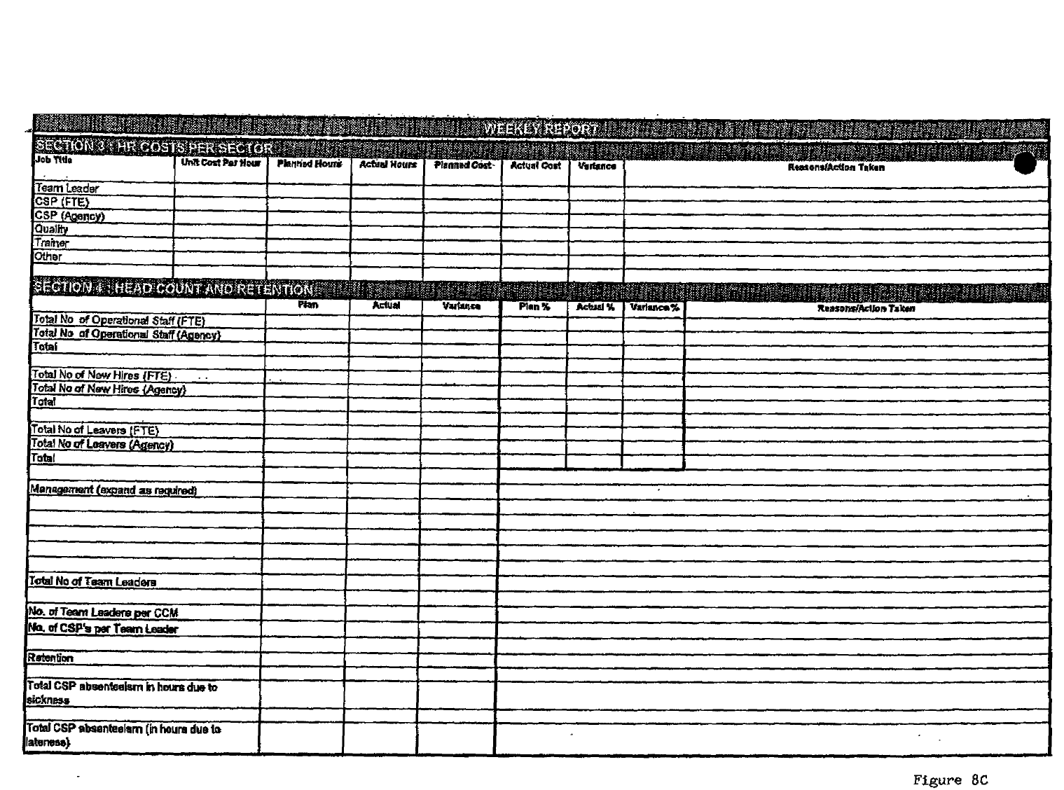

FIG. 6 shows a static agenda for the daily meeting;

FIG. 7 shows a blank action log;

FIGS. 8A to 8C shows a weekly report.

FIG. 1 shows:

1. Forecasting: This will be dependent upon the software available—if there is no means of forecasting in the contact center a mechanism will be developed to allow the contact center to accurately measure demand.

2. Deliverables: Conduct a meeting with senior management team to ensure we understand the overall objectives of the contact center. What is required to deliver to the business and how is it to be measured?

3. KPI establishment: Work with the contact center management team to translate the business objectives into KPIs for the center—these are then translated into team and individual objectives. These are also reviewed on an ongoing basis.

4. Weekly scheduling guide: using a combination of the forecast (anticipated demand) and the KPI (goal) we establish sag requirements to ensure demand is managed in a manner that ensures delivery of the objectives.

5. Timebound assignment plan: Team Leaders then use the above documentation to define hourly (in this embodiment) plans for each Agent.

6. Flexibility charts: preparation of charts documenting Agent skills and flexibility (capability)—so all Team Leaders are aware of how to best utilise the Agent and also have clear knowledge of replacement needs if Agent leaves.

7. Staff Rota: Prepare a weekly scheduling guide broken down to define start/finish times along with agreed breaks or training commitments.

8. Coaching schedule: Schedule of planned coaching within the Team.

9. Daily Variance Report: bespoke reports measuring KPI and key activities.

10. Team Leader Daily Variance Report Summary: Each Team Leader completes a summary for their line manager at the end of the day—outlining results and variances.

11. Call Center Manager (CCM) Weekly performance Report: May need customisation for a particular site—details performance across each activity with supporting analysis, financial elements and HR details.

12. Unit Management Report: Optional in dependence upon a number of contact centers. This needs to be prepared in line with site requirements.

13. CCM/Team Leader Daily Review Meeting: Using the static agenda and the discipline of action logs the Team Leaders of each activity will meet with their line manager to discuss variances from the plan and actions taken as a result.

14. Ops Director/CCM: Activity managers and/or CCM will meet once weekly to discuss performance versus plan and use the discipline of Action Logs to document decisions.

15. Action Logs/Static Agenda: Action Logs [FIG. 7] are a means of assigning responsibilities for actions to be taken—documents owner of the actions and timelines for completion.

This invention is concerned with a part of an integrated suite of operational management tools and processes. Working with it will enable at least Team Leaders and preferably all employees with a responsibility for other employees, to proactively measure, manage, analyse and report on day to day operations within the contact center.

The constancy part of the overall process will ensure the corporate level business goals are translated into contact center and team specific goals. FIG. 2 shows the goals roll down process. Once the goal has been set, the contact center management team make a plan to achieve the goal, assign tasks to Team Leaders, and follow up activities on a regular basis at each level.

Not many Agents working for a contact center will understand their contribution to a contact center target of, for example, $35 million sales. The goals roll down process ensures the Contact Center Manager is aware of the whole target, this will, then be divided, using historical management information, between the activities which contribute to the goal, and then allocate them to the Team Managers responsible for those activities. The Team Manager will then allocate goals to their team members.

By working with goals that are meaningful to each employee within the contact centre, Team Leaders and Agents have a fuller understanding of how the contact centre operates, how it fits in with the rest of the organisation, and can then understand targets set for the team. This promotes “out of the box” thinking and innovation, and contributes to a continuous improvement program.

The Reporting Documentation is efficient, in that the information does not have to be re-created at any stage, only added to. FIG. 3 describes the flow of information and how this is communicated and where the Reporting Documentation fits in with this process.

The diagram is an inverted pyramid, highlighting that it is the Team Leaders who start the monitoring process, the information they collect feeds not only the Daily Report and the Daily Summary, but the Weekly Report and where relevant, the Site Report. It is therefore vital the information collected by the Team Leaders is accurate to ensure that the ultimate report is valid and meaningful.

Reporting Documentation within the system is as follows:

Daily Report [FIG. 4]—this report comprises an hour by hour plan for the forthcoming day's activity, by Agents, in terms of KPI such as customer contacts per hour, % activity managed or turnaround times and so on. It also measures daily productivity by taking the total hours each agent is available to work, calculated against the hours the agent is paid. Any variance against the plan, or against the monitoring, is noted on the report as the day progresses. While an interval of one hour is given it may be as much as half of one working day or less than half an hour.

Daily Summary [FIG. 5]—this report summarises the daily performance of each Team (i.e. plurality of agents) in terms of KPI and in terms of overall customer contacts. It records productivity on a daily and weekly basis. Again, variances against the plans are recorded.

Weekly Report [FIG. 8]—this report takes the basic summary weekly information from the Daily Summary in terms of KPI, customer contacts, quality and productivity. In addition, it also addresses other HR issues, such as retention and overall sickness and lateness and calculates utilisation and capacity, as well as looking at weekly direct costs. Any variances against the plan are recorded.

Site Report—this optional report may be used where there is more than one contact centre within an organisation or a contact centre is divided into a number of activities. By reporting on a site by site (or activity) basis, it is possible to compare the performance of each site, in terms of operational and financial KPI and Human Resource issues such as retention and absenteeism. Variances are highlighted and explained.

Review Meetings—a series of short, focused meetings is included in order to communicate and discuss issues and variances. These are held as follows:—Daily Meetings between the Contact Centre Manager and the Team Managers, and Weekly Meetings between the Contact Centre Manager(s) and their line manager. These meetings ensure that swift action can be taken against any variances and that everyone is aware of how the contact centre is performing. These meetings also provide a forum for individuals to learn from other individuals and to promote open communication.

Action Logs [FIG. 7]—The action logs used in these meetings record issues and variances; who is responsible for the action and the due date. By using these logs, all issues can be tracked. If it is not possible to solve any issue in the meetings in which it is addressed, the issue will be escalated to the next level of management. Any action taken and the results will be communicated at the earliest possible opportunity within the meeting forum. This ensures the communication flow is both up and down the management chain.

As a Manager, the worst case scenario is not finding out about a small problem until it becomes a major issue. The Reporting Documentation measures performance on an hourly, daily and weekly basis (in this example), thereby ensuring that any major variances against the plan are identified at an early stage and corrective action can be taken.

### The Daily Report

The Daily Report is the responsibility of the Team Leader. This document provides a plan for each agent in their team (based on the Goals Roll Down process), and hourly monitoring against that plan in terms of KPI, and measurement of key activities or other actions (we need to ensure contact is an all embracing definition). It also monitors the hours an agent is available to work each day and hours paid. Any variances against the plan can be noted on the report.

This report may be completed manually or automatically such as by using a spreadsheet with information entered by the computer. Experience has shown that the manual method makes the Team Leaders “read” and “understand” the information although automated techniques have the advantage of being less labour intensive.

An example copy of a blank Daily Report is shown in FIG. 4.

The first page of the Daily Report [FIG. 4A] consists of an overall plan for the day, in terms of both number of customer contacts (by key activities) and KPI or service levels, with space to enter totals, and indicate reasons for any variances against the overall plan.

Before the start of each shift, the Team Manager should complete at least the goals (“Plan”) part of the Daily Report.

Section I: Planned KPI target, by hour per day, including, for example:

Planned overall team logged on time

Planned overall team unpaid breaks

Planned overall team paid breaks

Planned overall term productivity levels

Planned overall customer contacts per day by Key Activity

Planned KPI performance on an hourly basis and overall scores for the day

Section II [FIG. 4B] details individual Agent's performance, in terms of the following:

Planned star time

Planned unpaid breaks

Planned paid breaks

Planned logged on time

Planned productivity level

Planned number of customer contacts on an hourly basis (by key activity)

Planned cumulative number of customer contacts on an hourly basis (by key activity)

Planned total number of customer contacts per day.

What should be borne in mind before completing the plan?

To effectively plan for a team's deliverables in terms of activities whilst achieving the KPI within the contact centre, the Team Leader should be able to identify:

Agents who are on holiday (what impact does this have on the number of contacts required for the rest of the team?)

Agents who are likely to be sick (what impact does this have?). A Team Manager will know if employees are on long-term sick leave, e.g. if they have a doctor's certificate which has excluded them from work for a defined period.

What times will Agents take their breaks? (they will take/make fewer customer contacts in this hour)

Should each Agent working on the same key activity have the same number of contacts on their plan?

If there are new Agents in the team, what level of activity will be planned each day during their training?

Are there are external factors such as marketing activity could affect the plan?

A plan should be completed for each Agent in terms of:

A plan for hours to be worked

A plan for sick leave

A plan for holidays

A plan for lieu time

### Monitoring Against the Plan

Once the plan is in place, the Team Leader should check the plan is in line with their overall goal and the Agents' planned hours are in line with the staffing schedule. If not, adjustments should be made accordingly.

When the Team Leader is happy with the plan, they are responsible for communicating the daily target to each Agent. Agents cannot be expected to perform against a target unless they know what the target is.

Each Team Leader will monitor the performance of their Agents every hour [i.e. at a first interval] against the planned activity. It is recommend that the Team Leader assimilate the actual information for each Agent at a convenient time each hour (e.g. on the hour or at 30 minutes past the hour). If there are variances against the plan, then the Team Leader must try to ascertain from the information available, the reasons for the variance—such as a low call volume (in a telephone call center example), lengthy calls or a system error. If an Agent is taking/making more calls than anticipated, then what is the reason for this? If the call length below average, is the quality as expected? If there is no obvious reason for the variance, the Team Leader should discuss the variance with the relevant Agent(s). Any significant variance must be recorded on the Daily Report.

Each Agent is given hourly feedback on performance against planned activity—over-achievement must be praised and unexplained variances must be discussed. This feedback is not necessarily a one-to-one session, merely an acknowledgement by the Team Leader of the performance of the Agent. This can be simply a literal pat on the back, a “thumbs up” or a quick chat. To cover the whole team need only take a few minutes during the hour. Where the Agents are located remotely from the Team Leader this process can occur by way of a telephone call or email and so on.

By conducting this exercise on an hourly basis, the Team leader will become proficient at reading and understanding data, and will be better placed to manage the Agents within their team.

By working with the reporting documentation on an hourly, daily and weekly basis, the Team Leaders will begin to “manage” their teams, both in terms of performance against targets and in terms of taking action against variances. The system provides real-time information and, as such, action taken as a result of variances in a real time environment, is meaningful to the Agent. Acting on variances at the end of the day, does not have the same impact as acting on them immediately—the information is fresh in the mind of the Agent. The Team Leader may also find this is the first opportunity they have had to understand the effect of what an Agent does has on productivity.

There are two key measures of efficiency in a contact center they are:

Accessibility

Productivity

Accessibility is a measure of Agent availability during a scheduled day and demonstrates effective time management—this is an Agent target.

Accessibility is the element that enables productive time, but is controlled at Agent level. It is a measure of the percentage of paid time during the scheduled day when an Agent is accessible to perform a key activity.

Productivity is a measure of work time in a scheduled day and demonstrates effective forecasting and resourcing—this is a management target

The reporting documentation ensures Team Leaders calculate productivity by Agents and by the team as a whole. We calculate productivity as follows:

The number of hours an Agent spends performing key activity work, divided by the number of hours they are paid, minus breaks, expressed as a %.

In order to understand productivity, it is important to understand the factors that affect productivity, one of which is Agent accessibility.

1. Productivity has a direct relationship with Agent accessibility—for example if we use the assume the following:

The Agent is paid for 8.0 hours work that day.

The Agent takes 1.5 hours paid breaks during the day.

Assume the Agent is accessible (available for work) for approx, 85% of that time—5.5 hrs.

Assume the Agent is intended perform key activities for 90% of their accessible time 5 hrs. Therefore with Agent accessibility of 85% one should achieve productivity of 77%

However if the Agent reduces the accessibility to 75% of that time—4.9 hrs

Performs key activities at the forecasted rate 90%—4.4hrs

The reduced accessibility reduces the overall productivity to 68%

2. As a business, we cannot realistically expect employees to work at 100% productivity. There will be times when an Agent has to leave their workstation, either to get a drink of water, to visit the bathroom or to answer a question from a colleague or manager.

External factors such as system downtime and undertaking tasks not forming part of their Key Activities, will also affect productivity. Whilst the amount of time this takes can be minimized, we have to accept a certain amount of time is “non-productive” time. Similarly if system issues prevents the Agent from performing key activities for 2 hrs

Agent accessibility remains at 85% of their time—5.5 hrs

However they perform key activities for only 3.5 hrs

The external issues have reduced overall productivity to 54%

In defining the daily plan the Team Manager plans each time period to achieve KPI of the centre using a combination of the following data:

Anticipated demand for that period

Resource available

Accessible time target

Productivity levels associated with the specific activity

Accessibility is the element that enables productive time, but is controlled at Agent level. It is a measure of the percentage of paid time during the scheduled day when an Agent is accessible.

The Team Manager will also gain a higher level of insight into how staff should be scheduled. The hour by hour plan for customer contacts and recording the actual number will often highlight times during the day when the team is either over or under-staffed. The information supplied by the Daily Report and Daily Summary will provide accurate information on the daily distribution of calls. This information can then be used to assist with more accurate staff scheduling.

If the Agent is distracted from the Key Activities by either an internal or external factor, the effect can have a dramatic effect, e.g.:

An Agent has a system problem that means that the key activity could not be delivered for 2 hours.

At the end of each shift, the Team Leader should complete the Daily Summary [FIG. 5], taking information from the Daily Report.

This report provides a high level overview on a daily and weekly basis, of information gathered in the Daily Report. The information required by the Daily Summary is the cumulative totals from the Daily Report, in terms of KPI data, number of customer contacts by activity type and calculated details of variances against the plan and actions taken. At the end of the week, the information from all Daily Reports, is consolidated into the Weekly Report by the contact center manager, which provides overall contact center performance for the week. The weekly report may simply be a collection of daily reports.

An example of a blank Daily Summary is shown in FIG. 5.

This report forms the basis of the Daily Review Meeting. The Daily Review Meeting, as its name suggests, is held on a daily basis, between the Contact Center Manager and all Team Leaders. This meeting, as far as possible, should be held at a regular time, and should always follow the same static agenda. These meetings should take between 15 and 30 minutes and should be held away from the call floor, to ensure no interruptions.

An example of a static agenda for the Daily Meeting is given in FIG. 6.

During this meeting, it is important to stick to the agenda and not to go off at a tangent, to ensure all items are covered. At this meeting, all Team Leaders should be prepared to discuss the days' performance from the information contained within the Daily Summary, and as such this information may input into the next day's planning, in terms of call volume and staffing. One Daily Meeting should include a review of staffing for the following week, looking at the schedule and making any necessary alterations.

During any review meeting, the Action Log is used to record actions, responsibility for the actions, due dates and dates completed. The action log should be reviewed each day —this is a vital communication tool, especially for actions that are escalated out of the contact center.

A blank example of the Action Log is shown in FIG. 7.

During the Daily Meeting variance is discussed and sometimes it is factors external to the contact center which cause variance. For example, a shortfall against planned customer contact, could have been caused by an Agent who did not have a working computer for 2 hours at the end of the shift The action could be for the Team Leader to contact IT to ensure the computers are functioning by the next shift.

Another example of a variance requiring an action could be the a large percentage of abandoned calls was caused by a national advertising campaign that was unexpected. The action here could be the contact center manager to speak to Marketing to ensure all marketing activity was planned and communicated in advance.

During the Daily Meeting, the Action Log is always reviewed as the first item on the agenda and the person responsible for each action is responsible for communicating progress against this action to the rest of the group.

Some actions will not be completed by the time the Action Log is full. In order to avoid having to look through sheets of Action Logs to identify actions not yet completed, it is recommended that actions are moved to a current log and crossed off their original sheet.

By monitoring each Agent's performance every hour (or at other regular intervals) issues are addressed before becoming major problems.

Setting Key Performance Indicators is an important part of the preparatory work for the present invention. This will be discussed in more detail below.

### Derivation of Key Performance Indicators KPI)

A key performance indicator has been defined as a metric that drives organisational goals and as a performance measure to strive for. It should be aspirational and motivational, it is an index of quality and efficiency and it has major implications for the overall cost efficiency of the contact center (and the units within it).

There are three stages to building usable KPI but, before considering each stage, we should bear in mind some important issues.

Firstly, it is vital not to pick KPI out of the air. It must be understood the impact they will have on cost, customer perception and performance. The KPI policy of a company will depend upon the business or marketing strategy of the organisation, standards for operation of contact centers and expectations of the customers.

Common errors in developing KPI are: developing KPI for which complete and accurate data cannot be collected, developing KPI that measure the right variable but which motivate people to act in a way which is contrary to the best interests of the business (i.e. to “make up the numbers”) or developing KPI that are complex and difficult to explain to others.

### STAGE 1

### Considering Others

The expectations of an organisation's customers need to be determined. Preferably, some form of customer research will be conducted and this may be conducted by the particular organisation or by the industry sector. There are two main issues which customers recall. These are:

how long it takes for their call to be answered; and

how quickly their query is resolved.

Some examples of the type of KPI which may be used are:

service level

conversion rate

abandoned calls

available time

wrap time

talk time

average call duration

calls per hour

In order to translate the goal into relevant KPI levels it is necessary to consider how the goal can be reached. For example, if the goal is to make $250,000 sales at what conversion rate does the team of Agents need to operate? The conversion rate can then be set as a team KPI. Measurement of this KPI will ensure that the team is on target to achieve the goal.

It is important to ensure that the individual Agent understands the KPI and his/her effect on them. KPI must be under the individual's control—the individual Agent has no control over the number of in-bound calls although he/she does have control over the conversion rate of calls taken. The KPI for an individual Agent must be linked to the business and team objectives, although it is possible to have different KPI for different people, based on their skills and experience. The KPI should be flexible as business needs change and must be attainable. If individual KPI are not attainable or are not perceived to be attainable then they will actually have a demotivating effect rather than a motivating one.

### STAGE 2

### Deciding What to Measure

There are two sets of measurements: quantitative and qualitative. A list of these is included in the following table.

| Quantitative (Hard Measures) | Qualitative (Soft Measures) |
|---|---|
| Average call length | Quality monitoring procedures |
| Abandoned rate percentage | Training attendance |
| Time to answer | Feedback sessions |
| Percentage calls answered within target | Buzz sessions |
| time | |
| Wrap time | Ideas schemes |
| Agent utilisation percentage | Percentage training time |
| Average number of calls to resolve | Percentage monitoring/ |
| customer case | coaching time |
| Percentage of cases resolved at first | Training attendance |
| contact | |
| Call outcome codes | Mystery shopping |
| Ratios of call outcome codes | Data capture |
| Percentage of escalations | Test calls |
| Number of customer complaints | Morale scoring |
| Absenteeism | Percentage holiday time |
| Percentage of trip to ACH | Incentive payments and trends |
| Sick hours/% sick time | Involvement and contribution |
| Hours worked Vs hours | Number of formal customer |
| available/Schedule | thank you/praise letters |
| Revenue per call | Customer satisfaction/perception |
| Sales per Agent | Staff feedback on systems |
| Upsell Percentage | User acceptance of systems |
| Cost per customer | Fit of system with operation |
| | requirements |
| Cost per call | |
| Cost per workstation | |
| Cost per minute | |
| Cost per case resolved | |
| Revenue per customer | |
| Retention | |
| Holidays | |
| Percentage system up time/downtime | |
| Number of hours system downtime | |
| Percentage system capacity utilisation | |
| Number of engaged calls | |

Some of these measures will now be discussed.

Often one of the business drivers or customer concerns is the speed at which calls to the contact center are answered. Two ways of measuring this are average speed of answer and percentage of calls answered in x seconds The former measurement does not provide a true understanding of how long it really takes for calls to be answered. For instance, if the majority of calls are answered quickly but a significant minority are only answered after a very long wait then the average speed of answer is likely to still be respectable. However, a significant minority of callers are being made to wait a long time. The latter measurement is more useful because it allows management to know how many customers waited longer than a desired time. This measure can conveniently be combined with a measure of the longest wait time as this gives an indication of the worst case scenario for contact center activity. Percentage of calls answered in x seconds is often shortened, for example, 90 PCA 15 which means that 90% of calls are to be answered within 15 seconds.

Reducing the target time to answer from, say, 80% of calls in 20 seconds to 80% of calls in 10 seconds can add 20 to 25% to the cost of running a contact center as staffing levels will need to increase. However, it needs to be considered whether that additional investment will make any difference to customer perceptions of service quality, Setting the PCA figure at the lower level can have quite dramatic implications on the staffing level of the contact center and therefore its cost effectiveness.

Therefore, we need to know whether customers actually care whether we answer their calls in under 10 seconds or under 20 seconds. Is the extra investment required for the faster response going to be justified by the returns? This question needs to be answered if the KPI set is to be meaningful.

Another KPI is abandon rates for incoming calls. While certain contact centers must provide a zero abandoned call rate (such as the emergency services) in the majority of cases this is not a realistic expectation. In many cases aiming for a zero or very small abandon rate means that you will end up over-staffing the center. The gain in additional revenue from not losing calls may well be consumed by the additional staff costs. It is worth noting that research indicates that for new prospects or enquiries only one third will give up if they do not receive an answer.

### STAGE 3

### The Sanity Check

Once the KPI have been identified and values determined it is important to step back for a sanity check. Consider the KPI and ask:

do they make sense?

how do they compare with the existing KPI (if any)?

do they adequately cover the areas of cost, quality and customer satisfaction?

do they reinforce the desired behaviour, long-term as well as in the short-term?

The final point is particularly significant. The question to ask is “will this KPI drive the desired behaviour?” and “what type of behaviour will it encourage?”.

From the previous table it is clear that there are two types of measures: quantitative (hard measures) and qualitative (soft measures). In the latter case some consideration should be given to how to ensure objectivity with the “soft” measures.

By using the “SMART” system for setting KPI, you will ensure they are:

Specific:

Specific KPI are clear and concise

If a KPI is unclear, the chances of working towards it effectively are greatly diminished. If possible avoid vague phrases such as “as soon as possible”, “kept to a minimum”, “most of the time”, etc.

Concisely stated KPI are generally easier to communicate and remember.

Measurable:

Must be able to collect data that is accurate and complete.

KPI therefore need to specify the measure by which attainment can be evaluated.

Measurements cam be stated as rates (90% accuracy), ranges (+−50%) or absolute quantities (20 outbound calls).

Types of measures to consider include:

Quality: how well the result is produced/performed and to what standard.

Quantity: how much/many of the results are produced or performed.

Cost; at what expense is the result produced/performed.

Attainable:

Since KPI are meant to motivate the individual towards enhanced performance, they need to be challenging yet realistic or attainable.

Conversely, inappropriately low KPI may not sufficiently challenge the individual or best serve the interests of the organisation.

Relevant:

Simply means don't measure things that are not important and will not help the organisation achieve its goal.

KPI must be relevant to what the organisation is tying to achieve, i.e. they must be aligned.

KPI must also be relevant to the individual position and level of responsibility and experience.

Timely:

Clear KPI set tie frames/deadlines. The time frame could require a KPI to be met by the end of the first quarter, within the current year, or by a specific date.

if the time frame is conditional, specify how or where it will be stated, e.g. “according to the time schedules agreed upon in the 16 June team leaders' meeting”.

While the present invention has been described in the context of a telephone call based contact center, it is equally applicable to other contact centers such as those that operate via a Website, via email, white mail and so on.

While claims have been formulated to the present invention it is to be understood that the protection conferred extends to the spirit and scope of the invention disclosed herein and any generalisation thereof.

1. A method of managing a plurality of agents working for a contact center, comprising:
preparing a plan for each agent for a forthcoming first period, which plan comprises at least one performance indicator value for each of a plurality of second periods of no more than half a day, shorter than the first period,
deriving, at least at the frequency of the second period a variance from the plan, for each of the agents, and
communicating, at least at the frequency of the second period, with each agent whose variance exceeds a threshold.

2. A method as claimed in claim 1, wherein the duration of the second period is between one half hour and two hours.

3. A method as claimed in claim 1, wherein the second period is substantially one hour.

4. A method as claimed in claim 1, wherein the second period is substantially one half hour.

5. A method as claimed in claim 1, wherein the second period is substantially two hours.

6. A method as claimed in claim 1, wherein the first period is one working day.

7. A method as claimed in claim 1, wherein a variance that does not exceed the threshold is noted for discussion subsequently.

8. A method as claimed in claim 7, further comprising a plurality of scheduled meetings between a Team Leader and each Agent at which variances that do not exceed the threshold are discussed.

9. A method as claimed in claim 1, firer comprising a plurality of scheduled meetings between at least one Team Leader and higher management.

10. A method as claimed in claim 9, wherein one scheduled meeting occurs per day,

11. A method as claimed in claim 1, further comprising a step of generating a report on at least one key performance indicator value from at least one information source,

12. A method as claimed in claim 11, wherein the generation of the report is conducted on a per Agent basis.

13. A method as claimed in claim 6, wherein further reports are generated daily and weekly.

14. A method as claimed in claim 1, further comprising at least one consequent action point.

15. A method as claimed in claim 14, wherein the consequent action point comprises scheduling a course for at least one agent.

16. A method as claimed in claim 1, wherein the first time period is determined by higher management.

17. A method as claimed in claim 1, further comprising maintenance of information regarding the capability for each Agent.

18. A method as claimed in claim 1, wherein at least one performance indicator value is are adjusted in response to variance from the plan
